(19) United States
(12) Patent Application Publication
(10) Pub. No.: US 2026/0322491 A1
(43) Pub. Date: Oct. 15, 2026

(54) FREE-SPACE OPTICAL TELECOMMUNICATION SYSTEM

(71) Applicant: Cailabs, Rennes (FR)

(72) Inventors: Thibault Michel, Rennes (FR); Olivier Pinel, Rennes (FR)

(21) Appl. No.: 19/485,386

(22) PCT Filed: May 17, 2024
(86) PCT No.: PCT/EP2024/063810

§ 371 Date: Nov. 18, 2025

(30) Foreign Application Priority Data
May 19, 2023 (FR) FR2304967

(51) Int. Cl. H04B 10/112; H04B 10/2507; H04B 10/2581; H04B 10/516

(52) U.S. Cl. CPC H04B 10/1121; H04B 10/2507; H04B 10/2581; H04B 10/516

(57) ABSTRACT

A free-space optical telecommunication system includes a modulation device that produces a plurality of mutually incoherent elementary light beams, each elementary light beam modulating the same digital data to be transmitted, and a processing device configured to combine the elementary light beams and thereby produce light radiation referred to as “combined” light radiation. The system also comprises a beam expander optical device, optically coupled downstream of the processing device for receiving the combined light radiation and for propagating free-space transmission radiation.

### CROSS-REFERENCE TO RELATED APPLICATIONS

This application is a national phase entry under 35 U.S.C. § 371 of International Patent Application PCT/EP2024/063810, filed May 17, 2024, designating the United States of America and published as International Patent Publication WO 2024/240697 A1 on Nov. 28, 2024, which claims the benefit under Article 8 of the Patent Cooperation Treaty of French Patent Application Serial No. FR2304967, filed May 19, 2023.

### TECHNICAL FIELD

The present disclosure relates to an optical telecommunication system designed to overcome the transmission difficulties associated with the distortion of the wavefront of a light radiation during its propagation. This distortion may originate in atmospheric disturbances during an optical communication in free space. More generally, this distortion is caused by the propagation of the light beam in its medium. The present disclosure has particular applications in the field of free-space optical telecommunications.

### BACKGROUND

In free-space optical telecommunication, a transmitter modulates light radiation (usually produced by a laser) with the information to be transmitted, the light radiation taking the form of a narrow transmission beam, typically from several centimeters to 1 meter, which is emitted in the direction of a receiver. After propagation in its medium (air will be used as an example in the remainder of this disclosure, but the medium can be of any nature, such as water in the case of underwater telecommunication), the light radiation is collected at a receiver and demodulated to recover the transmitted information.

As it propagates, the radiation produced by the transmitter is subject to atmospheric disturbances, and, in particular, to temperature and pressure variations, which lead to changes in the optical index and distortion of the radiation. These erratic disturbances, the variation dynamics of which is typically between 100 Hz and several kHz, lead to its deformation, which affects its wavefront. More precisely, disturbances tend to spatially redistribute energy in the radiation, producing random fluctuations in amplitude and phase. This deformation materializes in the form of “speckle” patterns in the spot formed by the projection of the beam onto the radiation collection device and by a scintillation phenomenon. This limits the data rate on the link between the transmitter and the receiver, and therefore the quality of the link. This is particularly the case when the pupil of the radiation collection device is relatively small compared to the size of the beam when it reaches this device, and therefore little of the energy of the transmission beam can be captured. This is particularly true of “uplink” communications to a receiver on a satellite, or of terrestrial “point-to-point” communications, in which the transmission beam propagates entirely through the atmosphere.

### BRIEF SUMMARY

One object of the present disclosure is to propose an optical communication system that at least partially overcomes the aforementioned problem. More specifically, one aim of the present disclosure is to provide a free-space optical telecommunication system that makes communication more reliable and/or offers a preserved data rate despite disturbances induced by the propagation medium.

With a view to achieving this object, the subject matter of the present disclosure proposes a free-space optical telecommunication system comprising:
a modulation device that produces a plurality of mutually incoherent elementary light beams, each elementary light beam modulating the same digital data to be transmitted;
a processing device optically coupled downstream of the modulation device and configured to combine the elementary light beams and thereby produce a light radiation referred to as “combined” light radiation;
a beam expander optical device, optically coupled downstream of the processing device, for receiving the combined light radiation and for propagating free-space transmission radiation.

According to other advantageous non-limiting features of the present disclosure, taken alone or according to any technically feasible combination:
the processing device comprises at least one multiplane conversion device;
the multiplane conversion device comprises a plurality of optical parts each having a reflective face for guiding the propagation of the elementary light beams, at least one of the reflective faces having a microstructuring configured to combine the elementary light beams and form, in the course of a plurality of reflections, the combined light radiation;
the microstructuring is also configured to shape the elementary light beams making up the combined light radiation;
the system is configured to conform the combined light radiation to a flat-top shape;
the flat-top shape has a circular cross-section to form a ring or disk;
the modulation device comprises a plurality of light sources associated with a plurality of modulators to produce the plurality of elementary light beams;
the light sources emit radiation of different wavelengths;
the modulation device comprises a broad spectrum source;
the optical telecommunication system comprises an offset optical fiber, optically arranged between an output port of the processing device and the beam expander optical device, for guiding the propagation of the recombined light beam;
the elementary light beams are each conformed to a linear combination of modes with similar group delays.
the offset optical fiber (F) is a degeneracy-lifting fiber, such as a step index fiber or an elliptical core fiber;
the optical telecommunication system comprises a shaping optical block arranged between the offset optical fiber and the beam expander optical device;
the beam expander optical device (T) is a telescope or a lens assembly.

### BRIEF DESCRIPTION OF THE DRAWINGS

Other features and advantages of the present disclosure will become apparent from the following detailed description of embodiments of the present disclosure with reference to the accompanying figures, in which:

FIG. 1 shows an optical telecommunication system according to the present disclosure;

FIG. 2 shows an example of a multiplane conversion device;

FIG. 3 shows a ring shape of the recombined radiation.

### DETAILED DESCRIPTION

For the sake of clarity, in the present disclosure light radiation or a light beam is defined as radiation formed from at least one mode of the electromagnetic field, each mode forming a spatio-frequential distribution of the amplitude, phase, and polarization of the field.

The “shape” of radiation or of a beam means the transverse distribution of the amplitude and the phase of the mode or the combination of the transverse amplitude and phase distributions of the modes making up this radiation.

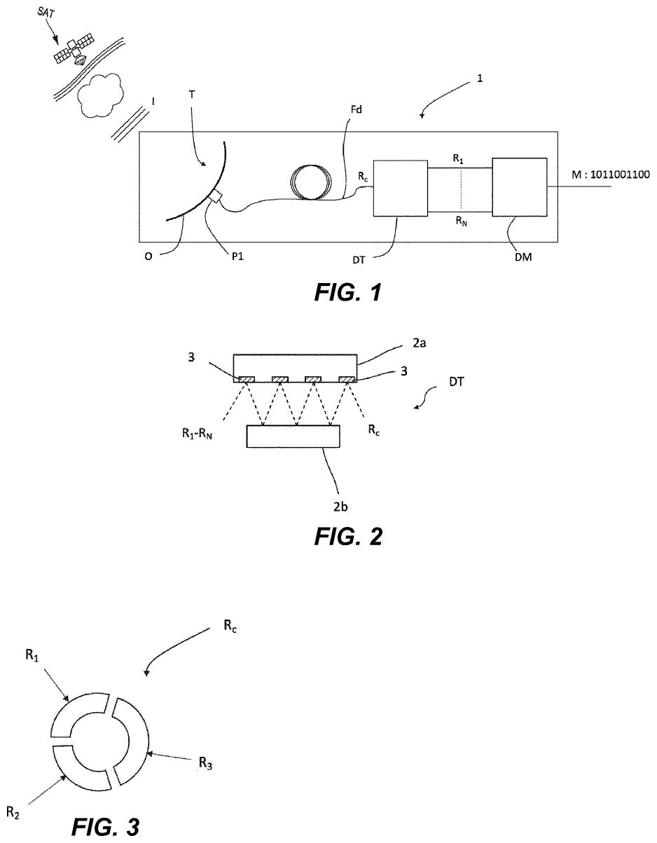

With reference to FIG. 1, an optical telecommunication system 1 conforming to the present disclosure is designed to produce transmission light radiation I carrying, by modulation, information to be transmitted. The transmitted light radiation is supplied to an optical receiver, capable of extracting information from the received radiation. In the example shown here FIG. 1, the optical receiver is arranged in a satellite SAT, but the telecommunication system of the present disclosure is by no means limited to this particular application. Generally speaking, the transmitter and the receiver can be positioned on land, at sea or in space, and propagate in any free space, the atmosphere in the case of land communication, or water in the case of marine communication. The transmitter and the receiver can be stationary, or move relative to one another.

The transmission light radiation I takes the form of a narrow beam directed toward the receiver. During its propagation in free space, the radiation emitted is subjected to atmospheric disturbances of the atmosphere, so that the incident light radiation I arriving at the base station housing the receiver has amplitude and phase spatial and temporal fluctuations. This phenomenon affects the shape of this radiation, which takes on a variable form over time, erratically, irregularly, and tends to spread spatially and distort, so that the energy actually received by the radiation collection device at the receiver is limited or even intermittent. The optical telecommunication system 1 of the present disclosure aims to overcome, at least in part, these difficulties by creating spatial diversity in the transmission radiation I, this diversity making it possible to attenuate the effects of fluctuations to allow the optical receiver to use the radiation and decode the transmitted message. This attenuation of fluctuations is based on the fact that each spatial mode of transmission radiation I perceives a different atmospheric layer and therefore creates a different speckle pattern on the target. If the light beams carried by these spatial modes are mutually incoherent, their intensities add up and average out into a more uniform pattern.

For this purpose, the optical telecommunication system 1 includes a modulation device DM producing a plurality of elementary light beams mutually incoherent elementary light beams R₁-R_{N}. Each elementary light beam R₁-R_{N} is modulated by the same digital data M to be transmitted. Generally speaking, an increasing number of elementary light beams increases the spatial diversity of the transmission radiation I and the robustness of the link, but at the cost of a more expensive system. In practice, the number of elementary light beams R₁-R_{N} may be between 2 and 50, and preferentially between 2 and 15.

“Mutually incoherent” is understood to mean that the light beams are not likely to interfere with one another on time scales comparable to or longer than the duration of one symbol of the digital data M. Typically, the targeted data rate is between 10 Gbauds/s and 50 Gbauds/s, or even up to 100 Gbauds/s.

The digital data can be encoded and modulated according to any suitable protocol, such as amplitude modulation or intradynary coherent modulation.

The modulation device DM comprises at least one light source associated with at least one modulator to which digital data are transmitted. Any modulation technique is suitable, for example, acousto-optic modulation (AOM), electro-optic modulation (EOM), semiconductor optical amplifiers (SOA) or direct modulation of the laser source.

The incoherent nature of the elementary light beams R₁-R_{N} produced can be achieved in a number of ways accessible to those skilled in the art.

By way of illustration, the source can be chosen to present a broad spectrum. The width of the source spectrum is determined by the target throughput and the number of elementary light beams. For example, a 10 Gbaud transmission using 10 elementary light beams means choosing a source spectrum width greater than 100 GHz.

Each elementary light beam can be formed from a portion of this spectrum, this spectrum portion being obtained by filtering.

Alternatively, light radiation produced by the broad-spectrum source and modulated by the modulator can be separated to produce the plurality of elementary light beams R₁-R_{N}. The modulation device DM may comprise a plurality of adjustable delays respectively arranged in the optical paths of the elementary light beams R₁-R_{N} in order to render them mutually incoherent, by selecting the delays so that they are large in relation to the coherence time of the source, but small in relation to the duration of a modulation symbol. The delays can be achieved using optical fibers of different lengths, patch cords of different lengths, or free-space lines with fixed or adjustable delays.

By way of illustration, the broad-spectrum source can be an Amplified Spontaneous Emission (ASE) source, a super-luminescent diode, or an EDFA source (erbium ion-doped fiber optic amplifier). Alternatively, it could be a spectrum-sliced incoherent light source described in D. Lee, V. V. Mai and H. Kim, “Mitigation of Scintillation in FSOC Using RSOA-Based Spectrum-Sliced Incoherent Light,” in IEEE Photonics Technology Letters, vol. 33, no. 5, pp. 227-230, Mar. 1, 2021.

But, advantageously, the modulation device DM comprises a plurality of light sources associated with a plurality of modulators to independently produce the plurality of elementary light beams R₁-R_{N}. The light sources can be chosen to emit radiation with wavelengths that are distinct from one another and sufficiently spaced to ensure their incoherence (for example, distinct from 10 GHz or 100 GHz or a few hundred GHz). This approach is advantageous in that it enables high-power transmission light radiation I to be produced by combining a plurality of independent sources.

Continuing the description of FIG. 1, the optical telecommunication system 1 also comprises a processing device DT optically coupled to the modulation device DM, downstream thereof. A plurality of optical connecting fibers, for example, a plurality of single-mode fibers, may be optically arranged between the modulation device DM and the processing device DT to guide the elementary light beams R₁-R_{N} to input ports of the processing device DT.

The processing device DT is configured to combine the elementary light beams R₁-R_{N} and to produce a so-called “combined” light radiation R_{c}. “Combined light radiation” refers to a radiation formed by the elementary light beams R₁-R_{N} copropagating (that is, propagating in a single direction).

In addition to this combining function, the processing device can also be used to shape the elementary light beams R₁-R_{N}that make up the combined light radiation R_{c}.

The processing device DT can be produced by bundling the ends of the connecting optical fibers parallel to one another. This bundle of optical fibers can, if required, be collimated with microlenses. In any case, the light radiation emerging from the fiber bundle forms the combined radiation R_{c}. The fiber bundle can be arranged in a matrix, or more generally the ends of the fibers in the bundle can be arranged in a line or in a plane, for example, in the shape of a disk or inscribed in a disk, to best form the combined light radiation R_{c}. The optical fiber bundle can be arranged so that the ends of the fibers are arranged in a ring, the central part of the ring not being provided with fibers and corresponding to an obstructed central area of a telescope, as will be described in a later section of this disclosure.

The processing device DT can also comprise various optical components to help shape the elementary light beams R₁-R_{N} making up the combined light radiation R_{c}. These may include, for example, at least one Diffractive Optical Element (DOE), a Spatial Light Modulator (SLM), an optical system imaging or including at least one lens, an axicon, at least one transmissive or reflective, non-spherical and non-planar optical element, such as an aspherical or freeform optical element.

Preferably, however, the processing device DT comprises, instead of or in addition to the elements just described, at least one multiplane conversion device referred to as “MPLC device” in the remainder of this disclosure. Such a device allows the spatial parameters of the elementary light beams R₁-R_{N} processed by the processing device and constituting the combined light radiation R_{c} to be well controlled, such as the direction of propagation of the elementary light beams R₁-R_{N} (this direction can be defined via the mean linear phase of the associated electromagnetic field), the position of the elementary light beams R₁-R_{N} in the combined beam R_{c} (defined as the position of the center of gravity of the intensity distribution of the beam in a plane perpendicular to the direction of propagation of these beams), the horizontal or vertical size of the elementary light beams R₁-R_{N} (defined as the standard deviation of the horizontal or vertical marginal intensity distribution), the ellipticity and divergence of the elementary light beams R₁-R_{N} in the combined radiation R_{c}.

For the sake of completeness, it is recalled that in an MPLC device, incident light radiation undergoes a succession of reflections and/or transmissions, each reflection and/or transmission being followed by free-space propagation of the radiation. At least some of the optical parts on which the reflections and/or the transmissions take place, and which guide the propagation of the incident radiation, have microstructured zones that modify the incident light radiation.

The term “microstructured zone” means that the surface of the optical part has on this zone a relief, which can, for example, be broken down in the form of “pixels” whose dimensions may be comprised between a few microns and a few hundred microns. These may be metasurfaces. The raised portion or each pixel of this raised portion has a variable elevation with respect to a mean plane defining the surface in question, of at most a few microns or at most a few hundreds of microns. Regardless of the nature of the microstructuring of the zones, an optical part having such zones forms a phase mask introducing a local phase shift within the transverse section of the radiation that is reflected there or transmitted there.

Thus, a light radiation that propagates within an MPLC device undergoes a succession of local phase shifts separated by propagations. The succession of these elementary transformations (for example, at least four successive transformations such as 8, 10, 12, 14, or even at least 20 transformations, for example) establishes an overall transformation of the spatial profile of the incident radiation. It is thus possible to configure the microstructuring of the microstructured reflection or transmission zones to transform a first light radiation, which, in particular, has a specific shape, into a second radiation whose shape is different.

The documents “Programmable unitary spatial mode manipulation,” Morizur et Al, J. Opt. Soc. Am. A/Vol. 27, No. 11/November 2010; N. Fontaine et Al., (ECOC, 2017), “Design of High Order Mode-Multiplexers using Multiplane Light Conversion”; U.S. Pat. No. 9,250,454 and US2017010463 contain the theoretical foundations and examples of practical implementation of a device MPLC.

As described in detail in the aforementioned documents, and with reference to the illustration in FIG. 2, the optical part(s) 2a, 2b forming the MPLC device and the microstructured zones 3 carried by this or these optical part(s) are designed and configured to combine the elementary light beams R₁-R_{N} and to form, in the course of a plurality of reflections, the combined light radiation R_{c}. The microstructuring can also be configured to shape the elementary light beams R₁-R_{N} making up the combined light radiation R_{c}.

The elementary light beams R₁-R_{N} received at the input ports are each broken down into a family of “input” modes. The energies of the elementary light beams R₁-R_{N} respectively present in the modes of the input family are transported and respectively shaped to modes of a family of “output” modes at the output port of the MPLC device. The MPLC device is configured, in particular, through the microstructuring of the microstructured zones, to respectively match the input family modes and the output family modes. It is a passive device, whose transfer function is particularly stable and robust.

For the purposes of this disclosure, and by way of example, the family of input modes may comprise Gaussian modes arranged spatially opposite the elementary light beams R₁-R_{N}. The family of output modes can be made up of N Hermite-Gaussian modes or N Laguerre-Gaussian modes. The MPLC device is configured to associate a Gaussian mode of the family of input modes to a mode of the family of output modes. The energy of a light beam R₁-R_{N} received at an input port is carried into the MPLC device to distribute and conform to the output mode with which it is associated.

Of course, the Gaussian, Hermite-Gaussian and Laguerre-Gaussian modes used as examples are for illustrative purposes only, and other modes could be chosen to perform this transformation.

It is not necessary that the output modes be spatially superimposed. This is particularly the case when the combined light radiation R_{c}is required to be ring-shaped. This is shown in FIG. 3, which shows the shape of the combined “ring-shaped” light radiation R_{c} formed by the combination of three elementary light beams R₁-R₃. These beams are shaped like annular sectors and are evenly distributed throughout the ring, without overlapping.

It is not necessary for the beams to be perfectly contiguous to completely cover the annular surface, as shown in FIG. 3. In other embodiments, for example, the elementary beams can be Gaussian in shape, spatially arranged in a ring. Alternatively, the elementary beams can each be formed by groups of Hermite Gaussian modes, each group being spatially arranged within the ring.

By spatially spreading the elementary light beams R₁-R_{N} (more precisely, the output modes of the MPLC device) without overlapping, for example, in disjointed annular sectors, the spatial density of energy is limited in the combined radiation and, further downstream, in the transmission radiation I. The energy density present in the transmission radiation I can thus be controlled so that it is safe for the eyes, which is an essential safety criterion to be met in an optical telecommunication system involving free-space propagation.

The aim is generally to produce a transmission beam with maximum far-field irradiance along its axis of propagation, in order to best illuminate the target and promote optical communication. This configuration can be achieved by forming a flat-plate transmission beam (known in the industry as a “top hat” beam) in the near-field at the beam expander device T. This beam can have a substantially circular cross-section, to form a disk or a ring. The output modes of the MPLC device can therefore be advantageously selected so that the combination of elementary light beams R₁-R_{N} operated by this device conforms as closely as possible to such a flat-plate beam.

Returning to the description in FIG. 1, the optical telecommunication system 1 also comprises a beam expander optical device T, optically coupled to the processing device DT, downstream of the latter. The beam expander optical device T receives the combined light radiation R_{c} and propagates the transmission radiation I in free space.

The beam expander optical device T can take any suitable form, such as a telescope or lens assembly.

As is well known per se, a telescope can be formed by a lens that comprises a concave mirror for free-space propagation of light radiation. Here, the combined radiation R_{c} received at an optical port P of the telescope can be projected onto the concave mirror by way of a second plane or convex mirror of the objective O. The second mirror, when present, leads to the formation of an obstructed central zone, of very low intensity, in the transmission light radiation I. This is why it can be interesting to form a ring-shaped combined radiation R_{c} (as mentioned in two previous passages of this disclosure), in order not to place light energy unnecessarily in a central portion of the combined radiation R_{c}, as this energy cannot be propagated in free space.

When the beam expander optical device T is a lens assembly, the combined radiation R_{c} can take the form of a disk.

The beam expander optical device T can be orientable so as to point and/or track a receiver, here located in the satellite SAT. The optical telecommunication system 1 can also comprise a device for guiding the transmission radiation I (such as a transmission radiation and, more generally, to correct any deviations in the pointing of the telescope T).

The modulation DM and processing DT devices are made up of a plurality of precisely assembled optical or photonic elements, which may be particularly sensitive to their operating environment. They are generally placed in a cabinet, a room, a vehicle or any other shelter in an operations center. It can therefore be advantageous to mechanically decouple and offset the beam expander optical device T from the other system components. In this way, it can be positioned at a point favorable to the transmission of transmission radiation I without inducing vibration in the upstream optical chain when, for example, the beam expander optical device T is mobile.

To allow this distancing, at least one offset optical fiber Fd can be provided, optically arranged between an output port of the processing device DT and the port P1 of the beam expander optical device T, to guide the propagation of the recombined light beam R_{c}. This fiber Fd is advantageously multimode. This fiber Fd can be typically between 1 m and 10 m or between 1 m and 50 m long. A very short fiber Fd can also be provided, for example, from 10 cm to 1 m, if the aim is simply to mechanically decouple the beam expander optical device T from the rest of the system 1.

When the output port of the MPLC device is coupled to such a multimode offset fiber Fd, the modes of the output mode family are preferably chosen to correspond to the eigenmodes of this offset fiber Fd. This configuration makes it possible to control the modal content of the radiation emitted at the fiber output, and therefore its divergence, and more generally the properties of the transmission beam I, in particular, its stability. For this purpose, it may be preferable to use the guided modes of the lowest index offset fiber, which favors low divergence. It is also possible to control the shape of the radiation leaving the offset fiber Fd so that it conforms to or maximizes the energy density supplied to the pupil of the beam expander optical device T.

Advantageously, therefore, the offset fiber is a degeneracy-free fiber, offering a single “clean” mode for at least some of the mode groups. This may be an index-hopping fiber or an elliptical-core fiber, for example.

More generally, the modes of the output mode family can be chosen so that each of these modes is formed by a linear combination of modes with similar group delays in the offset fiber. Similar is understood to mean that these delays do not differ from one another by more than 10% of the symbol delay (defined as the inverse of the transmission rate in GBauds), preferably to within 5%.

For example, each mode of the input mode family can be chosen as a linear combination of modes of the same fiber mode group. Remember that modes in the same mode group in a fiber propagate at identical speeds. Thus, by configuring the MPLC device as proposed above, the time spread of transmitted symbols is limited, allowing high-speed transmission, for example, in excess of 10 GBd, 25 GBd or even 33 GBd. By avoiding propagating an elementary light beam over several mode groups of the fiber, it is also ensured that the propagation time difference of the elementary light beams can be pre-compensated, beam by beam, for example, using a static delay element. This feature is particularly useful when the offset fiber is relatively long, for example, 10 m or more.

Of course, this offset optical fiber is not mandatory, and it is also possible to optically couple these two elements by simple free-space propagation of the combined radiation R_{c}. This is particularly the case when the processing device DT shapes the combined light radiation R_{c}, for example, in a ring shape, as proposed in a previous section.

The optical telecommunication system just described makes it possible to form a transmission radiation I with a high modal diversity, thus attenuating the effects of fluctuations in the radiation caused by atmospheric disturbances.

Naturally, the present disclosure is not limited to the embodiments described, and it is possible to add alternative embodiments without departing from the scope of the invention as defined by the claims.

A communication system according to the present disclosure may comprise other elements or devices than those presented in detail in the present disclosure.

For example, when an offset fiber Fd is provided between the processing device DT and the beam expander optical device T, an optical block can be added to shape the radiation produced by this fiber Fd before injecting it into the beam expander optical device T. This optical shaping block can thus be used to adjust the shape of the recombined radiation to the nature of the beam expander optical device T: for example, as a disk for a lens assembly and as a ring for a telescope. This optical shaping block can be implemented using any suitable optical element: diffractive optical parts, spatial phase modulators, optical systems imaging or comprising at least one lens, axicons, an aspherical or free-form optical element, an MPLC device.

It can also be envisaged that some of the elements making up the system can be used for both transmission and reception. This is particularly the case for the beam expander optical device T, such as a telescope or lens assembly, for example, for the offset fiber Fd when present, and even for the processing device DT.

1. A free-space optical telecommunication system, comprising:
a modulation device that produces a plurality of mutually incoherent elementary light beams each elementary light beam modulating the same digital data to be transmitted;
a processing device optically coupled downstream of the modulation device and configured to combine the elementary light beams and thereby produce a combined light radiation. the processing device comprising at least one multiplane conversion device comprising a plurality of optical parts each having a reflective face for guiding the propagation of the elementary light beams, at least one of the reflective faces having a microstructuring configured to combine the elementary light beams and form, in the course of a plurality of reflections, the combined light radiation, the microstructuring also being configured to shape the elementary light beams making up the combined light radiation;
a beam expander optical device optically coupled downstream of the processing device, for receiving the combined light radiation and for propagating free-space transmission radiation; and
an offset optical fiber, optically arranged between an output port of the processing device and the beam expander optical device for guiding the propagation of the recombined light beam, the elementary light beams each being conformed by the processing device to a linear combination of modes of the offset optical fiber with similar group delays.

2. The optical telecommunication system of claim 1, wherein the modulation device comprises a plurality of light sources associated with a plurality of modulators to produce the plurality of elementary light beams.

3. The optical telecommunication system of claim 2, wherein the light sources emit radiation of different wavelengths.

4. The optical telecommunication system of claim 1, wherein the modulation device comprises a broad spectrum source.

5. The optical telecommunication system of claim 1, wherein the offset optical fiber is a degeneracy-lifting fiber.

6. The optical telecommunication system of claim 1, further comprising a shaping optical block arranged between the offset optical fiber and the beam expander optical device.

7. The optical telecommunication system of claim 6, wherein the shaping optical block is configured to shape the combined light radiation into a ring or disk.

8. The optical telecommunication system of claim 1, wherein the beam expander optical device is a telescope or a lens assembly.

9. The optical telecommunication system of claim 5, wherein the offset optical fiber is a step index fiber or an elliptical core fiber.

10. The optical telecommunication system of claim 3, wherein the modulation device comprises a broad spectrum source.

11. The optical telecommunication system of claim 10, wherein the offset optical fiber is a degeneracy-lifting fiber.

12. The optical telecommunication system of claim 11, wherein the offset optical fiber is a step index fiber or an elliptical core fiber.

13. The optical telecommunication system of claim 12, further comprising a shaping optical block arranged between the offset optical fiber and the beam expander optical device.

14. The optical telecommunication system of claim 13, wherein the shaping optical block is configured to shape the combined light radiation into a ring or disk.

15. The optical telecommunication system of claim 14, wherein the beam expander optical device is a telescope or a lens assembly.
